(19) United States
(12) Patent Application Publication
(10) Pub. No.: US 2026/0061999 A1
(43) Pub. Date: Mar. 5, 2026

(54) DRIVING ASSISTANCE SYSTEM, DRIVING ASSISTANCE DEVICE, DRIVING ASSISTANCE METHOD, AND PROGRAM

(71) Applicant: DENSO CORPORATION, Kariya-city (JP)

(72) Inventors: RYOZO YAMASHITA, Kariya-city (JP); RYOMA NIIHARA, Kariya-city (JP); MASAHIRO TAKAHASHI, Kariya-city (JP); YUKIMASA TAMATSU, Kariya-city (JP); KIYOKAZU TAKAGI, Kariya-city (JP)

(21) Appl. No.: 19/379,427

(22) Filed: Nov. 4, 2025

Related U.S. Application Data
(63) Continuation of application No. PCT/JP2024/015863, filed on Apr. 23, 2024.

(30) Foreign Application Priority Data
May 9, 2023 (JP) 2023-076990

(51) Int. Cl. B60W 30/09; B60N 2/00; B60W 30/095; B60W 40/08; G06V 20/58; G06V 20/59; G06V 40/18; G06V 40/20

(52) U.S. Cl. CPC B60W 30/09; B60N 2/0029; B60W 30/0956; B60W 40/08; G06V 20/58; G06V 20/59; G06V 40/18; G06V 40/28; B60N 2210/40; B60W 2420/403; B60W 2540/106; B60W 2540/12; B60W 2540/223; B60W 2540/225

(57) ABSTRACT

A driving assistance device is provided that is configured to: determine whether or not a current situation is a risk situation where there is a possibility of collision with an object, based on an output signal of an external sensor detecting an environment around the vehicle; execute assistance control for the vehicle to avoid the collision with the object, based on determining that the current situation is the risk situation; determine whether or not a preparatory action for avoiding the collision has been performed by a driver, based on an output signal of a motion sensor that detects the driver's motion; and change execution timing of the assistance control depending on whether or not the preparatory action has been performed within a given determination time period.

### CROSS-REFERENCE OF RELATED APPLICATIONS

This application is a continuation application of International Patent Application No. PCT/JP2024/015863 filed on Apr. 23, 2024, which designated the U.S. and claims the benefit of priority from Japanese Patent Application No. 2023-076990 filed in Japan on May 9, 2023. The entire disclosures of all of the above applications are incorporated herein by reference.

### TECHNICAL FIELD

The present disclosure relates to a technology to assist driver's driving operation.

### BACKGROUND

There is a driving assistance device that notifies a driver of a possible collision between the driver's vehicle and another object such as a preceding vehicle by a warning sound.

### SUMMARY

According to one aspect of the present disclosure, a driving assistance device is configured to: determine whether or not a current situation is a risk situation where there is a possibility of collision with an object, based on an output signal of an external sensor detecting an environment around the vehicle; execute assistance control for the vehicle to avoid the collision with the object, based on determining that the current situation is the risk situation; determine whether or not a preparatory action for avoiding the collision has been performed by a driver, based on an output signal of a motion sensor that detects the driver's motion; and change execution timing of the assistance control depending on whether or not the preparatory action has been performed within a given determination time period.

### BRIEF DESCRIPTION OF DRAWINGS

Objects, features and advantages of the present disclosure will become more apparent from the following detailed description made with reference to the accompanying drawings. In the drawings:

FIG. 1 is a diagram illustrating an overall configuration of a driving assistance system;

FIG. 2 is a diagram illustrating a variation of a motion sensor;

FIG. 3 is a functional block diagram of a driving assistance ECU;

FIG. 4 is a flowchart illustrating a warning timing determining process;

FIG. 5 is a flowchart illustrating another example of the warning timing determining process; and

FIG. 6 is a diagram illustrating an example of variation of a warning threshold.

### DETAILED DESCRIPTION

There is a technology for a driving assistance device that notifies a driver of a possible collision between the driver's vehicle and another object such as a preceding vehicle by a warning sound, and that adjusts output timing of a warning sound according to degree of the driver distraction. The technology includes evaluating a degree of driver distraction based on a driver's line of sight direction detected using a camera.

Various configurations for controlling output of warning sounds using driver's line of sight direction are under consideration. In one hypothetical example, when an object is in the driver's line of sight direction, the volume of the warning may be lowered or the output timing of the warning sound may be delayed. According to the hypothetical example, it is expected to reduce a possibility of giving the driver a hassle. The object herein may be an object that may possibly come into contact with the host vehicle.

The developers of the present disclosure have studies the above hypothetical example and realized that there are cases where the driver fails to recognize the object even though the object is in his or her line of sight (so-called “cognitively looking aside”), however. If the driver fails to recognize the object with his or her eyes on the object, the above hypothetical example may provide inappropriate output timing of the warning sound.

The present disclosure is made based on the above consideration or point of view, and it is one of objectives to provide a technology that can perform assistance control more appropriately.

According to a first aspect of the present disclosure, a driving assistance systems is provided that comprise: an external sensor that detects an environment around a vehicle; a motion sensor that detects motion of a driver; and a controller that executes assistance control for the vehicle to avoid collision with an object, wherein the controller is configured to: determine whether or not a current situation is a risk situation where there is a possibility of the collision with the object, based on an output signal of the external sensor; execute the assistance control based on determining that the current situation is the risk situation; determine whether or not a preparatory action for avoiding the collision has been performed by the driver, based on an output signal of the motion sensor; and change execution timing of the assistance control depending on whether or not the preparatory action has been performed within a given determination time period.

If the driver is aware of the risk, it is expected that he or she can take some action to avoid. Paradoxically, if such preparatory action is not observed, the driver may not recognize the object even though the object is in his or her line-of-sight direction.

According to the driving assistance system of the present disclosure, the execution timing of the assistance control is determined based on the presence or absence of the preparatory action. Therefore, even in a situation where an object is in the driver line-of-sight direction and but he or she is not aware of the object, the assistance control can be performed appropriately.

According to a second aspect of the present disclosure, a driving assistance metho for a vehicle to avoid collision an object is provided that comprises: determining whether or not a current situation is a risk situation where there is a possibility of the collision with the object, based on an output signal of an external sensor detecting an environment around the vehicle; executing assistance control for the vehicle to avoid the collision with the object, based on determining that the current situation is the risk situation; determining whether or not a preparatory action for avoiding the collision has been performed by a driver, based on an output signal of a motion sensor that detects the driver's motion; and changing execution timing of the assistance control depending on whether or not the preparatory action has been performed within a given determination time period.

According to a third aspect of the present disclosure, a program is provided that comprises instructions causing a computer to perform: determining whether or not a current situation is a risk situation where there is a possibility of collision with an object, based an input signal from an external sensor detecting an environment around a vehicle; executing assistance control for the vehicle to avoid the collision with the object, based on determining that the current situation is the risk situation; determining whether or not a preparatory action for avoiding the collision has been performed by a driver, based on an input signal from a motion sensor that detects the driver's motion; and changing execution timing of the assistance control depending on whether or not the preparatory action has been performed within a given determination time period.

According to a fourth aspect of the present disclosure, a first driving assistance device is provided that comprises: a communicator for communicating with another device; and a controller that executes assistance control for a vehicle to avoid collision with an object based on data received by the communicator, wherein the controller is configured to: acquire, via the communicator, a detection result of an external sensor detecting an environment around the vehicle; determine whether or not a current situation is a risk situation where there is a possibility of the collision with the object, based on an output signal of the external sensor; execute the assistance control, based on determining that the current situation is the risk situation; acquire, via the communicator, a detection result of a motion sensor detecting motion of the driver; determine whether or not a preparatory action for avoiding the collision has been performed by the driver, based on the detection result of the motion sensor; and change execution timing of the assistance control depending on whether or not the preparatory action has been performed within a given determination time period.

The above driving assistance method, program, and driving assistance device correspond to the driving assistance system, and provide the same operational effects as the driving assistance system.

According to a fifth aspect of the present disclosure, a second driving assistance device is provided that comprises a communicator for communicating with another device; and a controller that executes behavior control for a vehicle to avoid collision with an object based on data received by the communicator, the behavior control including steering control or braking control, wherein the controller is configured to: acquire, via the communicator, a detection result of an external sensor detecting an environment around the vehicle; determine whether or not a current situation is a risk situation where there is a possibility of the collision with the object, based on an output signal of the external sensor; start the behavior control, based on determining the current situation is the risk situation; acquire, via the communicator, a detection result of a motion sensor detecting motion of the driver; determine whether or not a preparatory action for avoiding the collision has been performed by the driver, based on the detection result of the motion sensor; and change an operation pattern of the behavior control depending on whether or not the preparatory action has been performed within a given determination time period.

According to the second driving assistance system above, the operation pattern of the behavior control is determined based on whether or not the driver has performed the preparatory action. Therefore, even in a situation where the driver is not aware of the object, the behavior control can be performed in an appropriate manner. The behavior control may be understood as a form of the assistance control.

Embodiments of the present disclosure will be described using the drawings. The present disclosure is not limited to the following embodiments and may be implemented with various changes within the sprit and scope of the present disclosure. Various variations may be implemented in combination as appropriate to the extent that no technical contradictions arise. The present disclosure also includes not-explicitly-stated configurations combining multiple variations. In the following description, like reference symbols are used for components having like functions to avoid specific description. If only part of a configuration is mentioned, the description elsewhere may be applied to the other.

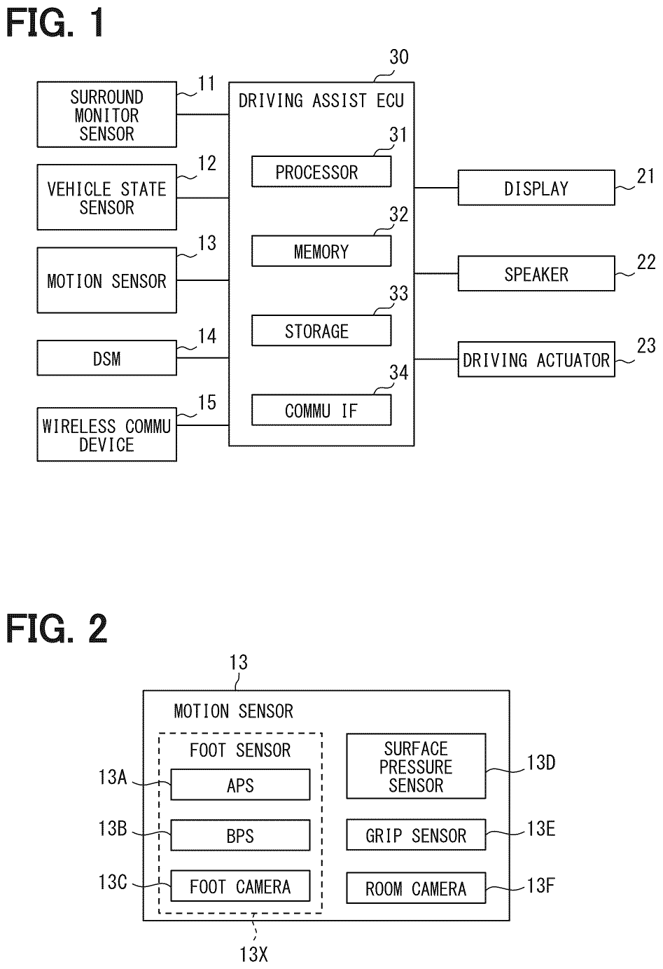

FIG. 1 shows an example of a schematic configuration of the driving assistance system 100 according to the present disclosure. A host vehicle in the following may refer to a single vehicle including the driving assistance system 100. A host vehicle lane in the present disclosure may refer to the lane where the host vehicle is traveling among the multiple lanes of the road. An adjacent lane may refer to a lane adjacent to the host vehicle lane. The host vehicle lane may be paraphrased as an ego lane. A preceding vehicle in the present disclosure may be understood as, among vehicles in front of the host vehicle, a vehicle that is traveling in the same lane as the host vehicle and is closest to the host vehicle.

The driver in the present disclosure may refer to a person seated in the driver's seat, i.e., a driver's seat occupant. The driver may be understood as a person who has an authority and responsibility for driving operations. The host vehicle may be a remotely operated vehicle, controlled remotely by an operator present outside the host vehicle. The operator herein may refer to a person authorized to control the vehicle remotely from outside the vehicle. The Operator is included in the driver. The driver's seat may be an operator's cockpit, located outside the vehicle.

The following driving assistance system 100 can be implemented with modifications as appropriate to conform to local laws and customs and the characteristics/equipment of the host vehicle. A system in the following may refer to the driving assistance system 100, unless otherwise noted.

### <Overall Configuration of the Driving Assistance System>.

The driving assistance system 100 includes various components, as shown in FIG. 1 by way of example. In other words, the driving assistance system 100 includes a surround monitoring sensor 11, a vehicle state sensor 12, a motion sensor 13, a driver status monitor (DSM) 14, and a wireless communicator 15. The driving assistance system 100 further includes a display 21, a speaker 22, a driving actuator 23, and a driving assistance ECU 30. ECU is an abbreviation of Electronic Control Unit.

The driving assistance ECU 30 is connected to each of the above devices/sensors, such as the surround monitoring sensor 11, through an in-vehicle network for mutual communication. The intra-vehicle network is a communication network built within the vehicle. The standards for the in-vehicle networks may be Controller Area Network (hereafter referred to as CAN: registered trademark), Ethernet (registered trademark), etc. Some devices/sensors may be directly connected to the driving assistance ECU 30 by dedicated signal lines. The form of connection between devices may be modified as needed.

The surround monitoring sensor 11 is a sensor that detects an object in a detection range. The surround monitoring sensor 11 performs sensing on the environment around the host vehicle. The surround monitoring sensor 11 may be paraphrased as an external sensor or an autonomous sensor. The driving assistance system 100 may include a plurality of surround monitoring sensors 11. The driving assistance system 100 may include a front camera and a millimeter wave radar as the surround monitoring sensors 11.

The front camera is a camera arranged to the host vehicle to capture images of the front of the vehicle at a specific angle of view. The front camera may be arranged at the top of the windshield on a vehicle cabin side, a front grille, or a roof top. The front camera may include a camera body unit and a camera ECU. The camera body unit is a module including an image sensor and a lens. The camera body unit successively generates image frames at given frame rates. The camera ECU includes a processor and memory. The processor includes a CPU (Central Processing Unit), GPU (Graphics Processing Unit), etc. The Camera ECU is an ECU that detects predetermined objects by applying recognition processing to image frames. The camera ECU may be configured to detect and specify an object registered as a detection target, using a deep learning-based classifier. The camera ECU also calculates relative position coordinates of the detected object relative to the host vehicle, based on the position information of the detected object in the image frame.

Objects detected by the front camera include moving objects such as pedestrians and other vehicles. The detection target objects of the front camera may include geophysical objects, including road edges, ground objects such as road surface markings, and structures arranged along the road. The road surface markings include a lane marking representing a lane boarder, a crosswalk, a stop line, a conduit zone, a safety zone, and a regulatory arrow. The structures arranged along roads include road signs, guardrails, curbs, utility poles, and traffic signals.

In addition to the front camera, the driving assistance system 100 may include a side camera that captures images of the sides of the vehicle and a rear camera that captures images of the rear of the vehicle. The function to detect detection target objects by analyzing camera images may be provided by other ECUs, such as the driving assistance ECU 30. The arrangement of functions within the driving assistance system 100 can be changed as needed.

The millimeter wave radar is a device that transmits a probe in a given direction and analyzes receiving data of reflected wave generated by reflection of the transmitted search wave at an object, and thereby detects the relative position and relative speed of the object relative to the host vehicle. The search wave may be millimeter or quasi-millimeter wave. The driving assistance system 100 may include a forward millimeter wave radar and a rear millimeter wave radar. The front millimeter-wave radar is a millimeter-wave radar that transmits search waves toward the front of the vehicle. The rear Millimeter Wave Radar is a millimeter wave radar that transmits search waves toward the rear of the vehicle. Each millimeter wave radar generates data indicating the relative position and relative speed of the detected object and outputs the data to the driving assistance ECU 30, etc. as detection results. In addition to the aforementioned moving object, the detection target objects of the millimeter wave radar may include three-dimensional structures as landmarks.

The surround monitoring sensor 11 may include LiDAR or sonar. The LIDAR is an abbreviation of Light Detection and Ranging or Laser Imaging Detection and Ranging. The LiDAR is a device that emits laser beams to generate 3D point cloud data indicating the location of reflected points in each detection direction. The combination of surround monitoring sensors 11 in the driving assistance system 100 may be modified as needed. The data indicating the detection result of each surround monitoring sensor 11 is input to the driving assistance ECU 30.

The vehicle state sensor 12 is a sensor that detects information on the state of the host vehicle. The vehicle state sensors 12 may include a vehicle speed sensor, a steering angle sensor, an acceleration sensor, a yaw rate sensor, and a shift position sensor. The vehicle speed sensor is a sensor that detects the travel speed of the host vehicle. The steering angle sensor is a sensor that detects the steering angle. The acceleration sensor is a sensor that detects acceleration acting in the front-back direction of the host vehicle, lateral acceleration acting in the left-right direction, and so on. The yaw rate sensor is a sensor that detects the angular velocity of the vehicle. The shift position sensor is a sensor that detects the shift position of the transmission. The vehicle state sensor 12 outputs data indicating a current value of the physical state quantity being a detection target (i.e., a detection result) to the network in the vehicle. The data flowing in the vehicle network is used by the driving assistance ECU 30 as appropriate. The type of sensor used by the driving assistance system 100 as the vehicle state sensor 12 may be designed as appropriate.

The motion sensor 13 is a sensor that detects the driver's motion. The motion sensor 13 may include multiple sensors. As shown in FIG. 2, the motion sensor 13 may include an accelerator pedal sensor (APS in FIG. 13A, a brake pedal sensor (BPS in FIG. 13B, a foot camera 13C, a surface pressure sensor 13D, a grip sensor 13E, and a room camera 13F.

The accelerator pedal sensor 13A is a sensor that detects a depression amount of the accelerator pedal. The brake pedal sensor 13B is a sensor that detects a depression amount of the brake pedal. The pedal depression amount may refer to the amount by which the driver depresses the pedal. The pedal may be read as an accelerator pedal or a brake pedal. The pedal sensor in the following may be read as the accelerator pedal sensor 13A or the brake pedal sensor 13B.

The pressing down amount may be expressed in terms of angles, etc. The expression “accelerator pedal angle” in the following may refer to the depression amount of the accelerator pedal. The expression “brake pedal angle” may refer to the depression amount of the brake pedal. A state in which the pedal depression amount/pedal angle is 0 corresponds to a state in which the pedal is not depressed by driver. The accelerator pedal sensor 13A and the brake pedal sensor 13B each output the data indicating the pedal angle (i.e., the depression amount) to the driving assistance ECU 30.

The foot camera 13C is a camera for capturing the position/motion of the driver's foot near the pedal. The foot camera 13C may be arranged above the brake or accelerator pedal. The foot camera 13C may be arranged in the right of the accelerator pedal or in the left of the brake pedal. The foot camera 13C may be arranged at any location in an orientation that enables imaging of the driver's foot. The captured video signal of the foot camera 13C is output to the driving assistance ECU 30. The driving assistance system 100 may include a foot sonar/foot radar in addition to or in place of the foot camera 13C. The foot sonar/foot radar is a sonar/millimeter wave radar for detecting the position of foot. The foot sonar/foot radar may be arranged around the driver's foot area, such as above o on the side of the pedals. The position of the foot in the following may be the position of a portion from the toe to the ankle/heel.

The accelerator pedal sensor 13A, the brake pedal sensor 13B, and the foot camera 13C are sensors for detecting the driver's foot motion. In the present disclosure, a sensor for detecting the motion of the driver's foot such as the above is also referred to as a foot sensor 13X. The foot sonar/foot radar may be included in the foot sensor 13X.

The foot camera 13C, the foot sonar, and the foot radar all correspond to a foot position sensor that detects the position of the driver's foot. The expression “foot position sensor” in the following may be replaced by the foot camera 13C, the foot sonar, or the foot radar. The surface pressure sensor 13D, described next, is also a sensor that indirectly detects foot motion. Therefore, the surface pressure sensor 13D can be interpreted as a kind of the foot sensor 13X and a kind of the foot position sensor. The pedal sensor may be paraphrased as a first sensor and the foot position sensor may be paraphrased as a second sensor or a sub-sensor.

The surface pressure sensor 13D is a sensor that detects the pressure acting on a seat surface. The surface pressure sensor 13D may be a sheet-like module, a so-called pressure sensor sheet, in which a plurality of pressure-sensitive points is arranged in a two-dimensional matrix. The surface pressure sensor 13D may be arranged to the entire seat surface. The surface pressure sensor 13D may be arranged to only the area where the back of the driver's knee or thigh touches. The surface pressure sensor 13D may be provided only in the area that is within 5 cm from the front edge of the seat surface. The surface pressure sensor 13D may be configured to detect the distribution of pressure acting on near the front edge of the seat surface or acting on the whole of the seat surface. The surface pressure sensor 13D outputs data indicating pressure distribution to the driving assistance ECU 30.

The driving assistance system 100 may include one or more load sensors, in addition to/in place of the surface pressure sensor 13D. The load sensors may be distributed in the four corners and the center of the driver's seat surface, for example. The multiple load sensors can also serve as a sensor to detect the distribution of pressure acting on the seat surface.

The grip sensor 13E is a sensor that detects the driver's grasp of the steering wheel. The grip sensor 13E may be configured to detect gripping force in addition to whether or not the steering wheel is being gripped. The grasping force serves as a parameter that indicates whether the driver is firmly gripping the steering wheel or simply touching it with a hand. The gripping force may be paraphrased as gripping pressure. The grip sensor 13E may be a capacitive touch sensor arranged on the outer surface of the steering wheel. The grip sensor 13E may be a pressure sensor on the steering wheel. The pressure sensor detects the pressure with which the driver grips the steering wheel. The grip sensor 13E may be a piezoelectric ceramic sensor using a piezoelectric ceramic. The grip sensor 13E outputs data indicating the driver's grip state of the steering wheel to the driving assistance ECU 30. The grip sensor 13E corresponds to a hand sensor.

The room camera 13F is a camera arranged to capture the driver's face and upper body. The room camera 13F may be mounted on, for example, the top of the instrument panel, the top edge of the windshield, or the A-pillar on the driver seat side. The room camera 13F may be mounted inside the vehicle in a position and orientation that enables capturing the driver's upper body motion and head motions. The video signal of the room camera 13F is output to the driving assistance ECU 30.

The room camera 13F may be integrated with the DSM 14 described next. The room camera 13F or the DSM 14 corresponds to a head sensor. The room camera 13F may be configured to detect the driver's hand motions in addition to the upper body/head. The room camera 13F may have a location, orientation, and angle of view that allows it to capture hand motion relative to the shift lever and the steering wheel. The motion sensors 13 may include a touch sensor arranged to the shift position.

The DSM14 is a device that successively detects the driver's status by analyzing the driver's face image. The driver status may include the driver's face orientation (neck angle) and eye-opening degree. The DMS14 also detects the driver's line of sight direction by synthesizing a driver's face orientation vector and a driver's line-of-sight direction vector with respect to the face. The DSM 14 includes a visible light/infrared camera arranged in the cabin in an orientation to capture images of the driver's face. The DSM 14 may be arranged on an upper surface of the steering column cover with the optical axis facing the driver's headrest. Data indicating a detection result (e.g., line of sight direction) of the DSM 14 is transmitted to the driving assistance ECU 30. The DSM 14 corresponds to a line-of-sight detector. The DSM 14 may also be used as a head sensor.

The wireless communicator 15 is a device for the host vehicle to perform wireless communication with an external device. The External device may include some or all of the following: a server, a traffic information center, a roadside unit, and a different vehicle. The wireless communicator 15 may be configured to be capable of short-range communications. The short-range communication may include vehicle-to-vehicle communication, which is direct communication between vehicles, and roadside-to-vehicle communication, which is direct communication between a vehicle and a roadside unit. The short-range communication may be wireless communication with a communication range of several hundred meters. The short-range communication method (protocol) may be Dedicated Short Range Communications (DSRC) corresponding to IEEE 802.11p, or cellular V2X (PC5/SideLink/Uu). The Wireless communicator 15 may receive vehicle information from surrounding vehicles. The vehicle information may include speed, current position, direction indicator operation state, acceleration, movement trajectory, etc. The surrounding vehicle herein may refer to a vehicle that exists within the range of the vehicle-to-vehicle communication. The wireless communicator 15 may also receive information about different vehicles from the roadside unit. The information on the surrounding vehicle received by the wireless communicator 15 may be used by the driving assistance ECU 30 to detect a different vehicle in the blind spot of the surround monitoring sensor 11 or the driver.

The display 21 is a device that displays images according to the video signal input from the driving assistance ECU 30. The display 21 may be a Head-Up Display (HUD), a meter display, or a center display. The HUD is a device that projects an imaginary image that can be perceived by the driver by projecting image light onto a given area of the windshield. The meter display is a display located in the area in front of the driver's seat in the instrument panel. The center display is located in the center of the instrument panel in the width direction of the vehicle. The meter display and center display may be LCD or OLED displays.

The speaker 22 is a device that outputs sound corresponding to a signal input from the driving assistance ECU 30. The expression “sound” in the present disclosure may include notification sound (warning sound), voice, music, etc. The display 21 and the speaker 22 are informing devices for notifying the driver of information. The driving assistance system 100 may include a vibration generator or ambient light as another notification device. The vibration generator is a device used to provide vibration stimulation to the driver's body, such as the hands, back, or chest. The vibration generator may be arranged to the steering wheel or the driver's seat. The vibration generator may be a device that vibrates the seat belt. The ambient light is a lighting device including multiple light emitting diodes (LEDs) that can be adjusted for emission color and intensity. The ambient lights may be arranged to the instrument panel or the steering wheel.

The driving actuator 23 is an actuator for the host vehicle traveling, i.e., accelerating, decelerating, and steering. The driving actuator 23 includes a brake actuator and a steering actuator. The driving actuator 23 may include an electronic throttle or a motor for traveling. The steering actuator may be an EPS (Electric Power Steering) motor. Other ECUs, such as a steering ECU, a hybrid control ECU, an engine ECU, a motor ECU, a brake ECU, etc., may be interposed between the driving assistance ECU 30 and the driving actuator 23.

In addition to the above, various in-vehicle devices may be connected directly or indirectly to the driving assistance ECU 30. The driving assistance ECU 30 is communicably connected to a locator and a map storage unit, via the in-vehicle network/using dedicated cable. The locator is a device that calculates and outputs the position coordinates of the host vehicle using positioning signals transmitted from positioning satellites constituting the Global Navigation Satellite System (GNSS). The map storage unit is a storage device in which map data is stored. The map data stored in the map storage unit contains three-dimensional shapes of roads, locations of road surface markings such as lane markings, and locations of traffic signs, with the accuracy required for automated driving, etc. The driving assistance ECU 30 may read map data in the range corresponding to the current position and use the map data to recognize the traveling environment.

The driving assistance ECU 30 is a device that assists the driver's driving operation by presenting information to the driver or performing some driving operations on behalf of the driver based on signals input from the various in-vehicle devices mentioned above. The driving assistance ECU 30 corresponds to a driving assistance device. The driving assistance ECU 30 may be an ECU that performs part of the driving operation on behalf of the driver by controlling the driving actuator 23 based on the detection result of the surround monitoring sensor 11. The driving assistance ECU 30 may provide, for example, adaptive cruise control (ACC), pre-crash safety (PCS) control, automatic emergency braking (AEB) control, and Lane Keeping Assist (LKA) control. The driving assistance ECU 30 may have so-called an automated driving function, which causes the host vehicle to travel autonomously in a given route. The driving assistance ECU 30 may be an automated driving system.

The driving assistance ECU 30 may be a computer including a processor 31, memory 32, storage 33, communication interface 34, and a bus connecting these. The memory 32 is a rewritable volatile storage medium. The memory 32 may be RAM (Random Access Memory). The storage 33 is a rewritable nonvolatile memory. The storage 33 may include several types of storage media, such as ROM (Read Only Memory) and flash memory. The storage 33 stores a driving assistance program, which is a program executed by processor 31. Execution of the driving assistance program by processor 31 corresponds to execution of a driving assistance method. The communication interface 34 is a circuit module for the processor 31 to communicate with other in-vehicle devices via the in-vehicle network. The communication interface 34 may include a PHY chip compliant with the communication standards of the in-vehicle network, etc. The communication interface 34 corresponds to a communicator.

### <On Configuration of Driving Assistance ECU>.

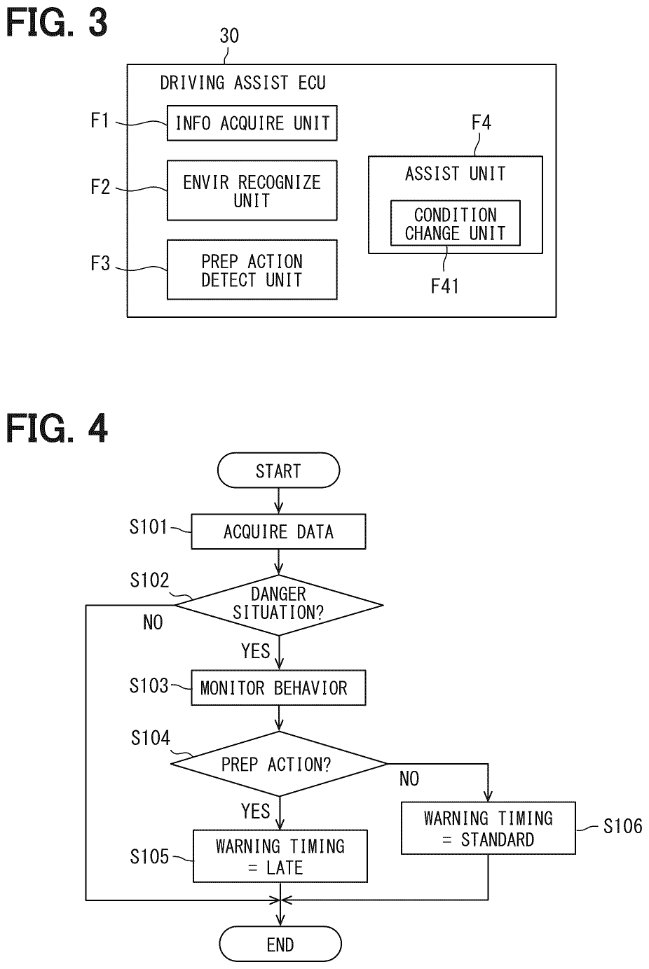

The driving assistance ECU 30 includes a plurality of functional units shown in FIG. 3 as functional units implemented by executing the driving assistance program. Specifically, the driving assistance ECU 30 includes an information acquisition unit F1, an environment recognition unit F2, a preparatory action determination unit F3, and an assistance unit F4.

The information acquisition unit F1 is a configuration to acquire information (data) for carrying out the driving assistance, from the in-vehicle devices. The information acquisition unit F1 acquires sensing data (i.e., detection results) from various surround monitoring sensors 11 including a front camera. The sensing data includes data about objects in the vicinity of the host vehicle, such as moving objects, ground objects, and obstacles. The data for each detected object may include the location of the object, the moving speed, and its type or size.

The information acquisition unit F1 also acquires data indicating the vehicle state, such as the host vehicle's travel speed, acceleration, yaw rate, and shift position, from the vehicle state sensor 12. In addition, the information acquisition unit F1 may acquire the position of the host vehicle from the locator. The information acquisition unit F1 may acquire vicinity map information by the map storage unit.

The information acquisition unit F1 may acquire data transmitted from the external device in cooperation with the wireless communicator 15. The information acquisition unit F1 may acquire the vehicle information transmitted by the vehicle-to-vehicle communication from the forward vehicle. The information acquisition unit F1 may also acquire information on a location of a stopped vehicle, a lighting status of a traffic signal, and a location and a movement direction of a pedestrian/bicycle, in cooperation with the wireless communicator 15.

The information acquisition unit F1 acquires data on the driver's motion based on the input signal from the motion sensor 13. The information acquisition unit F1 may successively acquire data on the depression amount of the accelerator pedal, the depression amount of the brake pedal, the foot position, the pressure distribution acting on the seat surface, the steering wheel grasping state, the upper body position, and the head position. Note that the information acquisition unit F1 does not have to acquire data on all the items mentioned above. The above items are examples. The information acquisition unit F1 may be configured to acquire data only some of the above items.

The information acquisition unit F1 may include a function to specify the position of the driver's foot by analyzing the video captured by the foot camera 13C. The information acquisition unit F1 may also have a function to specify the position of the driver's upper body and the position of the head by analyzing the image from the room camera 13F. The term “acquiring” in the present disclosure also includes generating/detecting/determining by the driving assistance ECU 30 through calculating based on data input from another devices/sensor, etc. This is because the arrangement of functions in the system can be changed as needed. Of course, the foot camera 13C may include a function to locate the foot by image analysis. The function to locate the driver's upper body/head by image analysis may be provided by the room camera 13F.

The various data successively acquired by the information acquisition unit F1 are stored in a temporary storage medium such as the memory 32 and used by the environment recognition unit F2, the preparatory action determination unit F3, and the assistance unit F4. The variety of information may be stored in memory 32 by being classified by type. In addition, so that the latest data is at the top, the variety of information may be sorted and stored. The data after a certain amount of time has elapsed since acquisition may be discarded.

The environment recognition unit F2 recognizes the traveling environment of the host vehicle based on various data acquired by the information acquisition unit F1. The environment recognition unit F2 may recognize the traveling environment of the host vehicle through a sensor fusion process that integrates the detection results of multiple surround monitoring sensors 11, such as a front camera and millimeter wave radar, with given weights.

The traveling environment includes road curvature, number of lanes, speed limit, weather, road surface condition, and traffic volume. The weather and the road surface condition may be specified by combining the recognition result from the front camera and the weather information acquired by the information acquisition unit F1. The road structure and the speed limit may be specified using the map data or the trajectory information of the preceding vehicle as well as the recognition result of the front camera.

The traveling environment also includes the location, type, and movement speed of an object in the vicinity of the vehicle. The environment recognition unit F2 recognizes the positions and behaviors of the preceding vehicle, the oncoming vehicle, the pedestrian, and the bicycle based on various data acquired by the information acquisition unit F1. In the following, the object in the vicinity of the host vehicle is also described as a peripheral object.

The environment recognition unit F2 calculates a collision risk for the peripheral object in the area related to the traveling direction of the host vehicle. When the host vehicle is moving forward, the environment recognition unit F2 calculates the collision risk for the peripheral object that is in a given range forward of the vehicle. The forward herein may include diagonally forward. If the host vehicle plans to make a lane change lane or a left or right turn, the collision risk may be calculated for the peripheral object exist diagonally rearward of the host vehicle or near the intersection.

The collision risk may be measured by Time-To-Collision (TTC) or Collision Margin (MTC: the Margin-To-Collision), etc. The TTC and MTC are such parameters that as the TTC/MTC is smaller, the collision risk is greater. The collision risk may be evaluated by TTC2nd, approach state evaluation Index (KdB), Time-Head Way (THW), or Risk Feeling (RF). The following description regarding the operations of units assumes that the environment recognition unit F2 uses TTC as the collision risk, by way of example. Specifically, the environment recognition unit F2 calculates the TTC for each different vehicle, each pedestrian, and/or each bicycle present forward of the host vehicle. A risk object in the following may be understood as an object whose TTC is less than a given value.

The preparatory action determination unit F3 is a configuration to determine whether a preparatory action for avoiding a collision has been performed by the driver, based on the output signal of the motion sensor 13, specifically, the data on the driver's behavior acquired by the information acquisition unit F1. Determining whether or not the preparatory action has been performed corresponds to detecting the preparatory action. Detecting and determining may be interchangeable in the present disclosure.

The preparatory action may be an action that leads to decelerating or steering. The preparatory action may be a reaction that the driver is supposed to take when the driver recognizes an object (i.e., a risk object) with which the host vehicle is likely to collide. The preparatory action may be interpreted as an action that indicates that the driver has recognized the risk object. The preparatory action can be paraphrased as risk perception response or avoidance preparation behavior. The preparatory actions may be broadly classified into (a) foot preparatory action, (b) upper body/head preparatory action, and (c) hand preparatory action.

Examples of the preparatory foot action may include (1) less pressing down of the accelerator pedal, (2) moving the right foot away from the accelerator pedal and moving the right foot to near the brake pedal, and (3) placing the right foot on the brake pedal. The above preparatory foot action may be determined from the time series data of the output of the accelerator pedal sensor 13A and the brake pedal sensor 13B. The preparatory action determination unit F3 may acquire the motion amount and direction of the foot position based on the images of the foot camera 13C and combine the motion amount and direction of the foot position with the pedal sensor output value to detect the preparatory action described above. The Time-series data for a certain parameter may be interpreted as data indicating observed values of the parameter over time, specifically, the data indicating a change of the parameter over time.

The preparatory action determination unit F3 may determine that an action of releasing the accelerator pedal has been performed, when the decrease in the accelerator pedal angle within a certain period of time is greater than a given value, or when the accelerator pedal angle is less than a given value. Moving the right foot away from the accelerator pedal and moving to near the brake pedal may be moving the right foot from the accelerator pedal by a given distance in a direction to the brake pedal (i.e., in the left direction). The preparatory action determination unit F3 may specify the right foot motion/movement amount based on the images of the foot camera 13C.

The preparatory action determination unit F3 may determine that the right foot is applied to the brake pedal, when the brake pedal angle is greater than 0 and less than a given value (e.g.,) 5°. The preparatory action determination unit F3 may determine that the driver's right foot is on the brake pedal, when the driver's right foot is on the brake pedal in the image of the foot camera 13C. An action of pressing the left foot against the footrest may be registered as the preparatory action. This left foot behavior can correspond to an action for supporting the body for sudden braking.

The preparatory action determination unit F3 may determine that the preparatory action has been performed, when the accelerator pedal angle or brake pedal angle has changed in a given pattern. The preparatory action determination unit F3 may also determine that the preparatory action has been performed, in response to the right foot position, determined by analyzing the image of foot camera 13C, having changed in a given pattern.

In typical, the pressure distribution on the seat surface can change when the driver moves the right foot. The pressure distribution pattern can be different between when the accelerator pedal is depressed by the driver and when the driver's foot is near the brake pedal. From this point of view, the preparatory action determination unit F3 may determine that the preparatory action has been performed, when the pressure distribution output by the surface pressure sensor 13D has changed in a given pattern. The preparatory action determination unit F3 may determine that the driver moved his/her foot toward the brake pedal, i.e., performed the preparatory action, when the pressure point corresponding to the thigh of the right foot moved from right to left. The preparatory action determination unit F3 may determine that the preparatory action has been performed, when the center of gravity of the pressure distribution has shifted to the left.

Examples of the preparatory action of the upper body/head may include (4) moving the upper body forward, (5) moving the face from side to side and (6) correcting the posture. The act of moving the upper body forward corresponds to an action of checking the hard-to-see areas when there are many obstructions. This action may be considered as one of the preparatory actions, since it is due to the intention to recognize a potentially risk object. The motion of the upper body forward may be detected by analyzing the video of the room camera 13F or based on the output of the DSM 14. The motion of the upper body forward may be detected based on the time series data of the pressure distribution output by the surface pressure sensor 13D.

The act of moving the face from side to side possibly corresponds to checking whether a lane change for avoiding the risk object ahead is feasible. Therefore, the act of moving the face from side to side may be considered as one of the preparatory actions. The preparatory action determination unit F3 may detect the act of moving the face side to side, based on the image of the room camera 13F or the output of the DSM 14.

Correcting the posture suggests a possibility of the driver's preparation for contact with the risk object or a sudden driving maneuver. Therefore, correcting the posture may be considered as one of the preparatory actions. The preparatory action determination unit F3 may detect the posture correcting, based on analysis of the video of the room camera 13F or the output of the DSM 14. Note that the head position moves upward when the driver corrects his or her driving posture. Therefore, when the head position moves upward, the preparatory action determination unit F3 may determine that the preparatory action has been performed. The preparatory action determination unit F3 may determine that the preparatory action has been performed, when the driver's upper body/head position, as determined by image analysis, has changed in a given pattern.

Examples of the preparatory action of the hand include (7) an action of increasing the force of gripping the steering wheel (firm grip). The preparatory action determination unit F3 may detect the above preparatory action based on the output signal of the grip sensor 13E. In cases of the driver gripping of the steering wheel with only one hand before detecting the risk object, the preparatory action determination unit F3 may determine that the preparatory action has been performed, in response the driver griping the steering wheel with both hands. The action of increasing the gripping force of the steering wheel may include the act of increasing the number of hands gripping the steering wheel from one hand to both hands.

A pattern model for detecting the preparatory action may be generated in advance by testing and/or machine learning, and stored in the storage 33. The traveling environment may be taken into account in determining whether the preparatory action has been performed. The preparatory action determination unit F3 may determine that the preparatory action has been performed, in response to a decrease in the accelerator pedal in a situation where the current travel speed is below the speed limit. The preparatory action determination unit F3 may also determine that the preparatory action has been performed, in response to a decrease in the accelerator pedal angle in a situation where the vehicle is traveling uphill. For example, the preparatory action determination unit F3 may determine that the preparatory action has been performed, in response to a decrease in the accelerator pedal angle by a given value or to less than a given value in a traveling environment where the accelerator pedal angle is supposed to be maintained/increased.

In another example, the preparatory action determination unit F3 may determine that the preparatory action has been performed, when the shift position is changed from the drive position to the brake position. The brake position herein refers to a shift position where the engine brake or regenerative brake acts. The drive position is the shift position for forward traveling where the engine brake or regenerative brake is relatively small. Changing the shift position from the drive position to the brake position is an operation causing deceleration. Therefore, the above operation can be interpreted as the preparatory action. When the host vehicle is a manual transmission vehicle, the preparatory action determination unit F3 may determine that the preparatory action has been performed, in response the shift down operation. The preparatory action determination unit F3 may detect the driver placing his or her hand on the shift lever as the preparatory action. The driver placing his or her hand on the shift lever may be detected based on the image of the room camera 13F or from the output of the touch sensor on the shift lever.

The preparatory action determination unit F3 may be configured to determine whether or not the driver has performed the above-described preparatory action within a given determination time period. The determination time period may be from the point in time when an object having the TTC less than a given determination start value appears to the point in time when the TTC of the object reaches a given determination end value. The determination start value may be set to 4 seconds, or 5 or 6 seconds, etc. The determination end value may be set to 2.5 seconds, 3 seconds, 3.5 seconds, etc. The determination end value may be set to a value smaller than the determination start value by one second or more. The determination time period may be the period of time from when the driving assistance ECU 30 recognizes that the situation is risky, to when the TTC reaches the below-described standard threshold. The driving assistance ECU 30 may regard an object having TTC less than the determination start value as the risk object. The threshold for setting a peripheral object as a risk object may be set to a value greater than the determination start value.

The assistance unit F4 provides the driver with a notification using a notification device such as the display 21 and the speaker 22. Various notifications/suggestions can be provided by displaying images on display 21 and/or by outputting voice messages from speaker 22.

The assistance unit F4 may be configured to perform, as its basis operation, outputting a warning sound from the speaker 22 to notify the driver of the risk of collision, when TTC of the risk object reaches the given standard threshold. The standard threshold may be set to 2.2 seconds, for example. The standard threshold may be set to another value, e.g., 1.8 seconds, 2 seconds, 2.4 seconds, 2.6 seconds, 3 seconds, etc. For illustrative purpose, the timing at which the TTC becomes the standard threshold is also referred to as standard timing.

In the present embodiment, in cases where there is no detection of the driver's preparatory action within the determination time period, the assistance unit F4 is configured to output a warning sound at the timing of the TTC reaching the standard threshold. On the other hand, in cases where there is detection by the preparatory action determination unit F3 of the driver's preparatory action within the determination time period, the assistance unit F4 sets the output timing of the warning sound to timing later than the standard timing. When the driver's preparatory action within the determination time period has been detected by the preparatory action determination unit F3 the assistance unit F4 may output a warning sound at the timing when the TTC reaches a given late threshold. The late threshold is smaller than the standard threshold by a given amount. The difference between the late threshold and the standard threshold may be 0.2 seconds, 0.4 seconds, 0.6 seconds, etc. As seen, the assistance unit F4 has as a sub-function the condition modification unit F41 that modifies the output timing of the warning sound according to whether or not the driver has performed the preparatory action within the determination time period. The output timing of the warning sound is also referred to as warning timing in the following units. In the present disclosure, thresholds for TTC that define the output timing of the warning sound, such as the late threshold and standard threshold, are also referred to as warning thresholds.

The assistance unit F4 automatedly starts braking control (so-called automated braking) at the timing when the TTC of the risk object falls below a given braking threshold. The braking threshold may be set to a value of 1.4 seconds or less (1.6 seconds or less in large vehicles), for example, to a value of 1.2 seconds.

When the TTC of the risk object becomes higher than a determination release value due to the driver's braking operation or the like after the start of the determination, the assistance unit F4 may determine that the risk situation has been left. The determination release value may be the same as the determination start value or may be set to a value larger than the determination start value by a given amount.

### Operating Examples

The flowchart in FIG. 4 shows an example of warning timing determining process by the driving assistance ECU 30. The flowchart shown in FIG. 4 may be executed periodically while the host vehicle is traveling. The processor 31 described as the subject executing the following steps may be replaced with the information acquisition unit F1, the environment recognition unit F2, the preparatory action determination unit F3, the assistance unit F4, or assistance unit F4, the depending on the context.

In the step S101, the processor 31 acquires the data from various in-vehicle devices. In step S101, processor 31 acquires the detection results of the surround monitoring sensor 11, the detection results of the motion sensor 13, and the travel speed of the host vehicle. Step S101 may be interpreted as the step of retrieving the received data stored in the buffer of the communication interface 34. The processor 31 executes step S102 following step S101. The process corresponding to step S101 may be performed periodically at or after step S102. In other words, step S101 may be executed at any time in parallel (independently) with step S102 and thereafter.

In step S102, the processor 31 determines whether or not the current situation of the host vehicle is a risk situation, based on the detection result of the surround monitoring sensor 11 acquired in step S101. In response to the object having the TTC smaller than a given value (e.g., the determination start value), the processor 31 may determine that now is the risk situation. The process by the processor 31 of calculating the TTC for each peripheral object based on the detection result of the surround monitoring sensor 11 may be included in step S101 or S102. The processor 31 may determine whether or not the current situation is the risk situation, based on data other than TTC.

Step S103 determines whether or not the driver has performed the preparatory action. The determination as to the preparatory action may be successively performed within the determination time period. The determination of whether or not the preparatory action has been performed may be made in a variety of ways, as described above. The determination of whether or not the preparatory action has been performed may be made based on a combination of time series data of one item with time series data of another item. Examples of such items include accelerator pedal angle, brake pedal angle, foot position, head position, and steering wheel grip force.

Upon determining in the preparatory action determination process (step S103) that the preparatory action has been performed, the processor 31 executes step S105. When no preparatory action has been detected within the determination time period (S104 NO), the processor 31 executes step S106.

Step S105 is a step of setting the warning timing to the timing later than the standard timing. Step S105 may be interpreted as a step of setting the warning threshold to the late threshold. When step S105 is completed, this flow is ended. Step S106 is a step of setting the warning timing to the standard timing. Step S106 may be interpreted as a step of setting the warning threshold to the standard threshold. When step S106 is completed, this flow is ended. Thereafter, when the TTC reaches the warning threshold set in step S105 or S106, the assistance unit F4 causes the warning sound to be output from the speaker 22.

### Effect

According to the above configuration, in cases where the preparatory action has been performed in the risk situation, the output timing of the warning sound is delayed as compared with cases where no preparatory action has been performed. This reduces a possibility of outputting a warning sound in a situation where the driver is aware of the risk object and is about to take evasive action. As a result, the possibility of providing hassle to the driver is reduced.

According to the above configuration, when no preparatory action has been performed in the risk situation, the warning sound is output at the standard timing. Even if the driver's line of sight is directed toward the risk object but the driver is not aware that the situation is risky, the output timing of the warning sound is not set to the late timing. This makes it easier for the driver to recognize the risk object and perform maneuver to avoid them.

In one aspect, the above embodiment may be interpreted as such a configuration that the execution timing of the assistance control (warning) when no preparatory action has been performed within the determination time period is earlier than that when the preparatory action has been performed. Because the execution timing of the assistance control is early in the case of absence of the preparatory action within the determination time period, it is possible to provide a long time period for the driver to perform operations after recognizing the risk object. The above configuration may also be interpreted as such a configuration that the execution timing of the assistance control when the preparatory action has been performed within the determination time period is later than that when no preparatory action has been performed.

<Warning Timing in Cases where No Preparatory Action has been Performed>.

In the above, when the driver's preparatory action is not detected within the determination time period, the warning sound is output at the timing of the TTC reaching the standard threshold (i.e., standard timing), but the present disclosure is not limited to this. A configuration may be such that, when the driver's preparatory action has not been detected within the determination time period, the assistance unit 4 may output the warning sound at timing earlier than the standard timing. To do so, the driving assistance ECU 30 may be configured to use an early threshold as the warning threshold, wherein the early threshold is greater than the standard threshold. The early threshold may be set to a value greater than the standard threshold by 0.2, 0.4, or 0.6 seconds.

In that case, the assistance unit F4 may adopt the standard threshold as the warning threshold when the driver has performed a primary preparatory action but has not performed a secondary preparatory action. The assistance unit F4 may be configured to set the warning threshold to the late threshold when the driver has performed the secondary preparatory action.

The primary preparatory action herein may refer to a minor (rudimentary) preparatory action such as taking the foot off the accelerator pedal or reducing the depression amount of the accelerator pedal. The primary preparatory action may be detected based on the output signal of the accelerator pedal sensor 13A, the foot camera 13C or the surface pressure sensor 13D.

Examples of the secondary preparatory action include moving the right foot to near the brake pedal, placing the right foot on the brake pedal, and faintly depresses the brake pedal. These behaviors may be detected based on the output signal of the brake pedal sensor 13B, the foot camera 13C or the surface pressure sensor 13D. Other examples of the secondary preparatory action include setting the shift position to the brake position or performing the shift down. These behaviors may be detected based on the output of the shift position sensor.

Other examples of the secondary preparatory action include strengthening the steering wheel gripping force and correcting the posture. These behaviors may be detected based on the output signal of the grip sensor 13E, the room camera 13F, or the surface pressure sensor 13D.

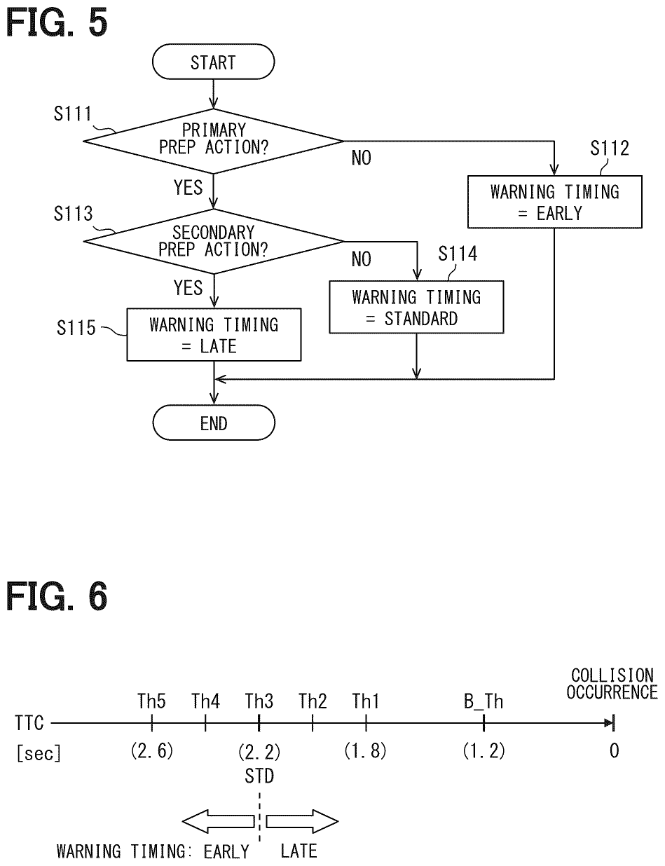

The processor 31 as the assistance unit F4 may determine the warning timing according to a procedure of steps S111-S115 shown in FIG. 5, when the determination time period has ended. First, in step S11, the assistance unit F4 determines whether or not the driver has performed the primary preparatory action within the determination time period. When the driver has not performed the primary preparatory action, i.e., no driver's primary preparatory action has been detected, the processor 31 executes step S112. Step S112 is a step of setting the warning timing to timing earlier than the standard timing. Step S112 may be a step of setting the warning threshold to the early threshold. When step S112 is completed, this flow is ended.

When the driver's primary preparatory action is detected in the determination time period, the processor 31 executes step S113. Step S113 is a step of determining whether not the driver has performed a secondary preparatory action within the determination time period. When the driver has not performed the secondary preparatory action within the determination time period, i.e., no driver's secondary preparatory action has been detected, the processor 31 executes step S114. Step S114 is a step where processor 31 sets the warning timing to the standard timing. Step S114 may be interpreted as a step of setting the warning threshold to the standard threshold. When step S114 is completed, this flow is ended.

When the driver's secondary preparatory action is detected in the determination time period, the processor 31 executes step S115. Step S115 is a step where processor 31 sets the warning timing to the timing later than the standard timing. Step S115 may be interpreted as a step of setting the warning threshold to the late threshold. When step S115 is completed, this flow is ended.

As described above, when the driver is in the risk situation but has not performed the preparatory action, the warning is output earlier than under normal circumstances. According to this configuration, it is possible to encourage the driver to take the preparatory action. As a result, safety can be further enhanced. The timing corresponding to the late threshold may be paraphrased as the late timing. The timing corresponding to the early threshold may be paraphrased as the early timing.

### <Timing Adjustment According to Preparatory Action>

In the above, a two or three-stage change in warning timing has been described. However, the warning timing may be changed in four or more stages. The warning threshold may be selected from the first to fifth thresholds shown in FIG. 6, depending on the driver's behavior. The multiple thresholds may be paraphrased as candidate values of the warning threshold actually applied.

In FIG. 6, “Th1” represents the fifth threshold, “Th2” represents the fourth threshold, “Th3” represents the third threshold, “Th4” represents the fourth threshold, and “Th5” represents the fifth threshold. The numbers in round brackets in FIG. 6 are threshold setting examples. “B_Th” represents the braking threshold. The point in time when TTC is zero represents the point in time when a collision occurs.

The first threshold is smallest among the candidate values. The first threshold may be set to 1.8 seconds, for example. The second threshold is the second smallest among the candidate values. The second threshold may be set to 2.0 seconds, etc. The first and second thresholds correspond to the late threshold described above.

The third threshold is the third largest/smallest among the candidate values. The third threshold may be set to 2.2 seconds, for example. The third threshold may be an intermediate value between the first and fifth thresholds. The third threshold may correspond to the standard threshold. STD in FIG. 6 refers to the standard threshold.

The fourth threshold is the second largest among the candidate values. The fourth threshold may be set to 2.4 seconds, for example. The fifth threshold is largest among the candidate values. The fifth threshold may be set to 2.6 seconds, for example. The fourth and fifth thresholds correspond to the early threshold described above.

The larger the warning threshold, the earlier the warning timing. The smaller the warning threshold, the later the warning timing. The aforementioned determination end value may be set to a value corresponding to the largest one (the fifth threshold in this) among the candidate values. The above candidate values are examples, and the specific values in terms of seconds may be changed as needed. The difference between the standard threshold and the second/fourth threshold may be 0.1 second, for example. The difference between the standard threshold and the first/fifth threshold may be 0.2 or 0.3 seconds.

When the assistance unit F4 is configured to select. from among the candidate values (warning timings), the warning threshold actually to be used, the assistance unit F4 may change the warning threshold according to what type (class) of the preparatory action the driver has performed. The assistance unit F4 may set the warning threshold to the fifth threshold when no preparatory action has been performed within the determination time period. The assistance unit F4 may set the warning threshold to the fourth threshold when the driver has reduced the accelerator pedal angle but the right foot remains on the accelerator pedal.

If the driver's right foot moves from on the accelerator pedal to the area between the accelerator pedal and the brake pedal within the determination time period, the assistance unit F4 may set the warning threshold to the third threshold. The assistance unit F4 may set the warning threshold to the second threshold when the right foot moves to on the brake pedal and the brake pedal angle is less than a given value. For illustrative purpose, the state in which the right foot is on the brake pedal and the brake pedal angle is less than the given value is referred to as a braking ready state.

The assistance unit F4 may set the warning threshold to the second threshold when any of correcting the posture, strengthening the steering wheel grip force and putting the hand on the shift lever has been performed by the driver in the braking ready state. The assistance unit F4 may set the warning threshold to the first threshold when the brake pedal angle exceeds a given value within the determination time period or the shift position is set to the brake position.

Even when the preparatory action has been performed as described above, the warning timing may be changed according to the type (class) of the preparatory action performed. Depending on the driver's degree of recognition of the risk object, the driver may behave differently (i.e., take the preparatory action differently). In the configuration, output timing of the warning sound depends on the driver's degree of recognition of the risk object. This enhances safety while reducing the possibility of providing hassle to the driver. In other words, the assistance unit F4 can output the warning sound at more appropriate timing.

The assistance unit F4 may evaluate a risk perception level based on the driver's behavior within the determination time period and determines the warning timing according to the risk perception level. The risk perception level herein is a parameter representing the degree to which the driver is aware of the risk object or the collision risk in front of the vehicle, etc.

For example, the assistance unit F4 may determine that the risk perception level is low, when the right foot is still on the accelerator pedal after the decrease in the accelerator pedal angle. When the assistance unit F4 evaluates the risk perception level as a low level, the assistance unit F4 may set the warning threshold to the fifth threshold to make the warning timing significantly early.

The assistance unit F4 may determine the risk perception level to be a medium level, when the driver is performing a given hesitation behavior after easing off the accelerator pedal. When the assistance unit F4 evaluates the risk perception to be the medium level, the assistance unit F4 may set the warning threshold to the fourth threshold. This control can make the warning timing slightly early. The hesitation behavior corresponds to a case where the driver has hesitated to decide whether or not to depress the brake pedal. The hesitation behavior may be a behavior of placing the right foot between the accelerator pedal and brake pedals, or repeated motion of the right foot to the left and the right.

The assistance unit F4 may also determine that risk perception level is a high level, when the driver eases off the accelerator pedal and then the driver moves the right foot onto the brake pedal without hesitation. The assistance unit F4 may be configured to set the warning threshold to the third threshold not to make early the warning timing, upon evaluating that the risk perception level is high. When the assistance unit F4 evaluates that the risk perception is at a high level, the assistance unit F4 sets the warning threshold to the second or first threshold to make the warning timing later than the standard timing.

A point or a value indicative of the risk perception level is preset for an each respective preparatory action. The assistance unit F4 may determine the warning timing based on the total of risk perception level values set to the preparatory actions observed within the determination time period. The assistance unit F4 may be configured so that the higher the total risk perception level values, the later the warning timing.

The assistance unit F4 may evaluate the driver's risk perception level by taking into account not only the driver behavior but also the traveling environment. For example, When the driver reduces the accelerator pedal angle in a situation where the current travel speed is less than the speed limit, the assistance unit F4 may determine that the risk perception level is high. The assistance unit F4 may also determine that the risk perception level is high when the driver reduces the accelerator pedal angle in a situation where the vehicle is traveling uphill. The assistance unit F4 may evaluate the risk perception level higher, when the accelerator pedal angle is reduced in a specific situation where the accelerator pedal angle is supposed to be maintained or increased.

When the driver reduces the accelerator pedal angle in a situation where the current travel speed exceeds the speed limit, this behavior may be done simply to comply with the speed limit and the driver may not be aware of the risk object. Therefore, the assistance unit F4 may be configured so that the operation of reducing the accelerator pedal angle in cases of the current travel speed exceeding the speed limit is not determined as the preparatory action.

The assistance unit F4 may change a criterion for determining whether or not the preparatory action has been performed or change a risk perception level evaluation method according to the driver's action history or the driver's habit. Some drivers may have a habit of placing their right foot between the accelerator pedal and brake pedals even in situations where no risk object is present. The assistance unit F4 may be configured so that when the driver has such a habit, the assistance unit F4 does not determine that the preparatory action has been performed even if the right foot is placed between the accelerator pedal and the brake pedal. When the driver has such a habit, the assistance unit F4 may determine that the risk perception level is low even if the right foot is placed between the accelerator pedal and the brake pedal. The assistance unit F4 may be configured to specify the driver's driving habit from the driver's action history and exclude the action caused by the habit from the list of preparatory actions prepared in advance.

### <On how to Use Sensor>.

The preparatory action determination unit F3 may use the pedal sensor to measure the depression amount of the accelerator/brake pedal. The preparatory action determination unit F3 may determine that the right foot is on the accelerator pedal when the accelerator pedal angle is greater than 0. When the brake pedal angle is greater than 0, the preparatory action determination unit F3 may determine that the right foot is on the brake pedal.

When both the accelerator pedal angle and brake pedal angle are 0, the preparatory action determination unit F3 may use another sensor to acquire the right foot position. Another sensor herein may be a foot position sensor such as the foot camera 13C, the foot sonar and the surface pressure sensor 13D. Thus, for recognizing the preparatory action, the preparatory action determination unit F3 may be configured to first detect the pedal depression amount, and if the pedal is not depressed, detect the foot position with the foot position sensor. The preparatory action determination unit F3 may use the foot camera 13C to measure the accelerator pedal angle and the brake pedal angle.

When the accelerator pedal angle or the brake pedal angle is greater than 0, the preparatory action determination unit F3 may deem that the right foot is on the pedal and may stop some or all of the foot position sensors. The preparatory action determination unit F3 may be configured to activate the foot position sensor when the accelerator pedal angle and brake pedal angle are 0 or less than a given value. According to this configuration, the power consumption of the entire system and the processing load of the processor 31 can be reduced.

The preparatory action determination unit F3 may change the enabled motion sensor 13 depending on the traveling scene. An enabled state of a sensor means that the power is ON and the preparatory action determination unit F3 uses the output value of the sensor to determine the preparatory action. A disabled state of a sensor may mean that the power is OFF or that the preparatory action determination unit F3 does not use the output of the sensor to determine the preparatory action.

For example, during low-speed traveling, the amount of pedal angle change is small. Therefore, it may be difficult to detect the preparatory action using the pedal angle within the low-speed traveling. In view of this, the preparatory action determination unit F3 may be configured to detect the preparatory foot behavior using the foot camera 13C, the foot sonar, or the surface pressure sensor 13D without using accelerator pedal sensor 13A nor the brake pedal sensor 13B, when the vehicle is traveling at low speed. In other words, while the vehicle is traveling at low speed, the preparatory action determination unit F3 may determine whether or not the preparatory action has been performed based not on the time series data of the pedal angle but on the time series data of the right foot position. This configuration can improve the accuracy of determining whether or not the preparatory action has been performed within low-speed traveling. In other words, in cases where no preparatory action has been performed, a possibility of erroneously determining that the preparatory action has been performed is reducible. Also, in cases where the preparatory action has been performed, the possibility of erroneously determining that the preparatory action has not been performed is reducible. The low-speed traveling in the present disclosure may be understood as a state in which the travel speed is less than a given value (e.g., 10 km/h).

When a visibility obstruction arranged, for example, near an intersection is detected by the surround monitoring sensor 11, the preparatory action determination unit F3 may determine whether or not the preparatory action has been performed using the room camera 13F or DSM 14, without using the foot sensor. The preparatory action determination unit F3 may determine that the preparatory action has been performed, upon detecting, using the room camera 13F or the DSM 14, that the driver's upper body/head has moved forward. The above behavior corresponds to a behavior for visibly checking a blind spot. In another traveling scene, the foot sensor may be used to determine whether or not the preparatory action has been performed. As described above, the processor 31 may change the sensor used to determine the preparatory action, depending on the traveling scene. The traveling scene may be classified into low-speed traveling, making a right/left turn, making a lane change, moving backward, stopped, starting, and cruising. The cruising refers to a state where the vehicle is traveling on the road without making a turn. The processor 31 may determine that the vehicle is cruising, when the direction indicator is not activated, and the vehicle speed is above a given value. The processor 31 may determine the traveling scene based on the output signal of the vehicle state sensor 12.

### <Correction of Foot Position>.

The position and angle of the driver's foot when the driver depresses the pedal can vary depending on the shape/type of shoe the driver is wearing. The foot position detection result by the foot camera 13C and the surface pressure sensor 13D can be affected by the shape (thickness) of the shoe. In view of this, the processor 31 may be configured to learn the foot position when the pedal is depressed and when the pedal is not depressed, from a history in the driving. The processor 31 may reflect a result of the learning into foot position estimation as needed.

The given time period (e.g., 5 minutes) after turning ON of the vehicle power may be a learning time period. The learning time period may be a period of time for processor 31 to learn (generate) a reference/classification model for estimating the driver's foot position based on the pressure distribution acting on the seat surface and/or the image of the foot camera 13C. The processor 31 may perform the learning of the pressure distribution and/or image features when the pedal is depressed, based on the pressure distribution and/or the image when the pedal angle exceeds a certain value within the learning time period. The processor 31 may perform the learning of the pressure distribution/image features when the pedals are not depressed, based on the pressure distribution/image at the pedal angle of zero.

Within the learning time period, the driving assistance ECU 30 may stop the function of adjusting the warning timing based on the preparatory action. Within the learning time period, the driving assistance ECU 30 may be configured to output the warning sound at the standard timing. After the end of the learning period, the driving assistance ECU 30 may be configured to perform the control to change the warning timing based on the presence or absence of the preparatory action. Within the learning time period, the driving assistance ECU 30 may be configured to determine the preparatory action without using the foot position sensor. According to the above configuration, the possibility of erroneously determining whether or not the preparatory action has been performed is reducible, where the erroneous determination is caused by individual differences or the like.

The processor 31 may set the warning timing to timing earlier than the standard timing, when the driver's line of sight is directed toward the risk but no preparatory action has been performed. The direction to the risk herein can be understood as a direction in which the risk object is present. The processor 31 may acquire the driver's line of sight direction from the output signal of the DSM 14. When the driver's line of sight is directed toward the risk but no preparatory action has been performed, it is highly likely that the driver is distracted or thinking about something different.

Therefore, in the above case, the early warning timing can enhance safety. When the driver's line of sight is not directed in a direction to the risk and no preparatory action has been performed, the processor 31 may set the warning timing to the standard timing or to the early timing.

Even if the preparatory action has been performed, when the driver's line of sight was not directed in the direction to the risk prior to the preparatory action, the processor 31 may set the warning timing to the standard timing. This is because it is unclear in this case whether the preparatory action detected is based on the driver's true awareness of the risk object. When the driver's line of sight is directed in the direction to the risk, the processor 31 may be configured to set the warning timing to the late timing in response to the preparatory action alone.

### Supplementation

Although the above describes the manners in which the output timing of the warning sound is changed according to the presence or absence of the preparatory action, the start timing of the automated braking may also be changed according to the presence or absence of the preparatory action. When no preparatory action has been performed within the determination time period, the assistance unit F4 may be configured to start the automated braking earlier than when the preparatory action has been performed within the determination time period. Specifically, when the driver's preparatory action has not been detected within the determination time period, the assistance unit F4 starts the automated braking at the timing when the TTC reaches a given standard braking threshold. When the preparatory action determination unit F3 detects that the preparatory action has been performed within the determination time period, the assistance unit F4 may start the automated braking at the timing when the TTC reaches a late braking threshold.

Both the standard braking threshold and the late braking threshold are thresholds (i.e., braking thresholds) for the TTC defining the automated braking start timing. The standard braking threshold and the late braking threshold may be pre-registered in the storage 33 or elsewhere. The late braking threshold is set to a value that is smaller than the standard threshold by a given amount. The difference between the late braking threshold and the standard braking threshold may be set to 0.2 seconds, 0.3 seconds, etc.

When the preparatory action has been performed within the determination time period, the timing to start the automated braking may be changed according to the type (content) of the preparatory action performed. The start timing of the automated braking may be paraphrased as braking start timing or intervention timing.

The above technical concept for controlling the output timing of the warning sounds may be applied to controlling the start timing of the automated braking. The assistance control is not limited to warning sound output, but may be automated braking. The assistance control may automatedly control the steering angle in a direction to avoid a collision. The processor 31 may be configured to change at least any one of the output timing of the warning sound, the start timing of the automated braking, and the start timing of automated steering, depending on the driver's behavior within the determination time period. The class/combination of that assistance controls whose execution timing are changed according to the driver's behavior within the determination time period may be changed as appropriate. The determination time period (the determination end value in particular) may be changed according to the assistance control.

The processor 31 may change an operation pattern of behavior control depending on whether or not the preparatory action has been performed within the determination time period. The behavior control in the present disclosure may be understood as steering control and/or braking control to avoid the vehicle colliding with an object. The behavior control may be understood as automated steering or automated braking for collision avoidance or collision damage reduction. The behavioral control is a form of the assistance control described above. The behavioral control may be paraphrased as avoidance control, intervention control, or automated control.

Changing the operating pattern of the behavior control may be changing the start timing of the behavior control or changing a manipulated value (initial manipulated value) at the start of the control. Changing the operation pattern may be changing both the start timing and the initial manipulated value. The manipulated value may be interpreted as magnitude of the behavior control. When the behavior control is braking control, the manipulated value may be interpreted as the magnitude of the braking force. The magnitude of the braking force may be expressed in terms of acceleration (deceleration). The magnitude of the braking force may be expressed in terms of jerk. When the behavior control is steering control, the manipulated value may be interpreted as steering amount/steering speed.

In the following, the case where the behavior control is the braking control will be described. The following description is applicable to the case where the behavior control is the steering control. When the behavior control is the braking control, the initial manipulated value can be called an initial braking force. Increasing the braking force can be interpreted as decreasing the acceleration in the negative territory, or in other words, increasing the deceleration.

In the present disclosure, the standard start timing of the braking control is referred to as the standard braking timing, and the standard value of the braking force generated by the braking control is referred to as the standard braking force. The standard braking timing may be interpreted as the timing when the TTC reaches the given standard braking threshold. The standard braking timing may be set to a value based on the vehicle type/weight of the host vehicle, and may be set to, for example, 1.2 seconds. The standard braking force may be set to −8 m/sec \hat{ }2, etc.

The processor 31 may set the initial braking force to the standard braking force when the preparatory action has been performed within the determination time period. When no preparatory action has been performed, the processor 31 may set the initial braking force to a value greater than the standard braking force by a given amount. The initial braking force may be set to −10 m/sec \hat{ }2 when the preparatory action has been performed. In this way, when no preparatory action has been performed, the processor 31 may make the initial braking force larger than when the preparatory action has been performed. The start timing of the braking control may be the standard braking timing regardless of the presence or absence of the preparatory action.

In cases where no preparatory action has been performed within the determination time period, the processor 31 may make earlier the execution timing of the braking control and make smaller the initial braking amount, as compared with cases where the preparatory action has been performed. When the preparatory action has been performed, the processor 31 adopts the standard braking timing and the standard braking force. When no preparatory action has been performed, the processor 31 may set the braking start timing to early timing and also set the braking force to a weak level. The early timing of the braking control may be earlier than the standard braking timing by 0.4 or 0.8 seconds. The early timing of the braking control may coincide with the output timing of the warning sound. The weak level of the braking force may be set to a value smaller than the standard braking force by a given amount. The weak level may be −2 m/sec \hat{ }2, −3 m/sec \hat{ }2, −4 m/sec \hat{ }2, etc. The weak level of the braking force may be paraphrased as weak braking force. The braking. control with the weak level may be paraphrased as weak braking.

The processor 31 may change the braking force into a strong level when the TTC reaches a given emergency value in a situation where the braking control with the weak level is in execution. The strong level may be set equal to the standard braking force or greater than the standard braking force by a given amount. The emergency value may be set to 1.2, 1.0, or 0.8 seconds, for example. The strong level of the braking force can be paraphrased as forced braking. In addition, the braking control at the strong level can be paraphrased as strong braking.

As described above, when no driver's preparatory action has been detected, the processor 31 may be configured to early initiate the weak braking. This configuration further enhance safety.

The processor 31 may execute control by combining the change in the warning timing with the change in the behavior control. When no preparatory action has been performed, the processor 31 may start the weak braking simultaneously with outputting the warning sound. The start timing of the warning sound and the weak braking when no preparatory action has been performed may be the same as the standard timing of the warning sound, or may be set to timing earlier than the standard timing by a given amount.

### APPENDIX (1)

The present disclosure also includes the following Technical Ideas. Also included in the present disclosure are driving assistance ECUs, driving assistance methods, and programs corresponding to the driving assistance systems described below.

(Technical Idea 1) A driving assistance system includes:
an external sensor (11) that detects an environment around a vehicle;
a motion sensor (13) that detects motion of a driver; and
a controller (31) that executes assistance control for the vehicle to avoid collision with an object,
wherein the controller is configured to:
determine whether or not a current situation is a risk situation where there is a possibility of the collision with the object, based on an output signal of the external sensor;
execute the assistance control based on determining that the current situation is the risk situation;
determine whether or not a preparatory action for avoiding the collision has been performed by the driver, based on an output signal of the motion sensor; and
change execution timing of the assistance control depending on whether or not the preparatory action has been performed within a given determination time period.

(Technical Idea 2) In the driving assistance system according to Technical Idea 1,
the motion sensor is configured to detect the preparatory action of a plurality of types, and
the controller is configured to control the execution timing so that the execution timing of the assistance control when the preparatory action has not been performed within the determination time period is earlier than that when the preparatory action has been performed within the determination time period.

(Technical Idea 3) In the driving assistance system according to Technical Idea 1,
the motion sensor is configured to be capable of detecting the preparatory action of a plurality of types, and
the controller is configured to:
set the execution timing so that the execution timing of the assistance control when the preparatory action has been performed within the determination time period is later than that when the preparatory action has not been performed within the determination time period; and
change a degree of how late the execution timing is, depending on what type of the preparatory action the driver has performed.

(Technical Idea 4) In the driving assistance system according to Technical Idea 3,
a risk perception level is set for each preparatory action, and
the driving assistance system is configured to control the execution timing of the assistance control when the preparatory action has been performed within the determination time period so that the higher the risk perception level set for the preparatory action having being performed is, the later the execution timing of the assistance control is.

(Technical Idea 5) In the driving assistance system according to any one of Technical Ideas 1-4,
the motion sensor includes a foot sensor (13X) that generates and outputs data on foot motion of the driver, and
the controller is configured to, based on the data on the foot motion output by the foot sensor, determine whether the preparatory action has been performed.

(Technical Idea 6) In the driving assistance system according to Technical Idea 5,
the foot sensor includes a sensor that generates data indicating a depression amount of an accelerator pedal and depression amount of a brake pedal, and
the controller is configured to, upon the depression amount of the accelerator pedal or the brake pedal having changed in a given pattern, determine that the preparatory action has been performed.

(Technical Idea 7) In the driving assistance system according to Technical Idea 6,
the foot sensor includes a foot position sensor that detects position of the foot,
the controller is configured to, upon the position of the foot having changed in a given pattern, determine that the preparatory action has been performed.

(Technical Idea 8) In the driving assistance system according to Technical Idea 7,
the foot sensor includes a sensor that generates data indicating a depression amount of an accelerator pedal and depression amount of a brake pedal,
the controller is configured to:
when the depression amounts of the accelerator pedal and the brake pedal are less than or equal to given values, enable the foot position sensor to determine, using a detection result of the foot position sensor, whether or not the preparatory action has been performed, and
when the depression amount of the accelerator pedal or the brake pedal exceeds the given value, determine, without using the detection result of the foot position sensor, whether or not the preparatory action has been performed, based on time-series data of the depression amounts of the accelerator pedal and the brake pedal.

(Technical Idea 9) In the driving assistance system according to any one of Technical Ideas 5-8,
the foot sensor includes a foot camera that images an area including the brake pedal and the accelerator pedal, and
the controller is configured to acquire data indicating the foot motion by analyzing an image of the foot camera.

(Technical Idea 10) In the driving assistance system according to any one of Technical Ideas 1-9,
the motion sensor includes a pressure sensor (13D) that detects pressure acting on a seat surface of a driver seat, and
the controller is configured to, upon the pressure having changed in a given pattern, determine that the preparatory action has been performed.

(Technical Idea 11) In the driving assistance system according to any one of Technical Ideas 1-10,
the motion sensor includes a head sensor (13F) that generates and outputs data on motion of the driver's head, and
the controller is configured to:
based on the data on the motion of the head output by the head sensor, determine whether the head has moved in a given pattern within the determination time period; and
upon the head having moved in the given pattern within the determination time period, determine that the preparatory action has been performed.

(Technical Idea 12) In the driving assistance system according to any one of Technical Ideas 1-11,
the motion sensor includes a hand sensor (13E) that generates and outputs data on motion of the driver's hand, and
the controller is configured to:
based on the data on the motion of the hand output by the hand sensor, determine whether or not the hand has moved in a given pattern within the determination time period; and
upon the hand having moved in the given pattern within the determination time period, determine that the preparatory action has been performed.

(Technical Idea 13) The driving assistance system according to any one of Technical Ideas 1-12 further includes:
a line-of-sight detector that detects a line-of-sight direction of the driver,
wherein the controller is configured so that:
the execution timing of the assistance control is settable to any of standard timing, late timing, and early timing;
the controller sets the execution timing of the assistance control to the late timing when the preparatory action that is of specific has been performed; and
the controller sets the execution timing of the assistance control to the early timing when the object possible to collide with the vehicle is in the line-of-sight direction of the driver and no preparatory action has been detected.

(Technical Idea 14) The driving assistance system according to any one of Technical Ideas 1-13 further includes:
a vehicle state sensor (12) that generates and outputs data indicating a state of the vehicle,
wherein the controller is configured to:
determine traveling scene from an output signal of the vehicle state sensor; and
change the motion sensor enabled, according to the traveling scene.

(Technical Idea 1A) A driving assistance system includes:
an external sensor (11) that detects an environment around a vehicle;
a motion sensor (13) that detects motion of a driver; and
a controller (31) that executes behavior control for the vehicle to avoid collision with an object, the behavior control including steering control or braking control,
wherein the controller is configured to:
determine whether or not a current situation is a risk situation where there is a possibility of the collision with the object, based on an output signal of the external sensor;
execute the behavior control based on determining that the current situation is the risk situation;
determine whether or not a preparatory action for avoiding the collision has been performed by the driver, based on an output signal of the motion sensor; and
change an operation pattern of the behavior control depending on whether or not the preparatory action has been performed within a given determination time period.

(Technical Idea 1B) A driving assistance method for avoiding collision of a vehicle with an object includes:
determining whether or not a current situation is a risk situation where there is a possibility of the collision with the object, based on an output signal of an external sensor detecting an environment around a vehicle;
executing behavior control for the vehicle to avoid collision with the object, based on determining that the current situation is the risk situation, wherein the behavior control includes steering control or braking control;
determining whether or not a preparatory action for avoiding the collision has been performed by the driver, based on an output signal of a motion sensor detecting motion of the driver; and
changing an operation pattern of the behavior control depending on whether or not the preparatory action has been performed within a given determination time period.

(Technical Idea 1C) A program includes instructions causing a computer to perform:
determining whether or not a current situation is a risk situation where there is a possibility of collision with an object, based on an input signal from an external sensor detecting an environment around a vehicle;
executing behavior control for the vehicle to avoid collision with the object, based on determining that the current situation is the risk situation, wherein the behavior control includes steering control or braking control;
determining whether or not a preparatory action for avoiding the collision has been performed by the driver, based on an input signal from a motion sensor detecting motion of the driver; and
changing an operation pattern of the behavior control depending on whether or not the preparatory action has been performed within a given determination time period.

### APPENDIX (2)

The various flowcharts shown in the present disclosure are all examples, and the number of steps in the flowcharts and the execution order of processes can be changed as needed. The controls shown in respective flowcharts may be executed in combination/parallel to the extent that no contradiction occurs. The terms acquisition, determination, detection, generation, and calculation may be interchangeable. Acquisition by a device of some data includes generation by the device of such data based on a signal input from another device/sensor.

The devices, systems, and methods described in the present disclosure may be provided by a dedicated computer comprising a processor programmed to perform one or more functions embodied by a computer program. The devices and methods described in the present disclosure may be provided using a dedicated hardware logic circuit. The devices and methods described in the present disclosure may be provided by one or more dedicated computers comprising a processor executing a computer program in combination with one or more hardware logic circuits. The processor may be any computing core, such as a CPU, MPU, GPU, or DFP (Data Flow Processor). Some or all of the functions provided by the processor 31 may be provided as hardware. Some or all of the functions provided by the processor 31 may be provided using any of a system-on-chip (SoC: System-on-Chip), IC (Integrated Circuit), and FPGA (Field-Programmable Gate Array).

A computer program includes instructions executed by a computer. The computer program may be stored on a computer-readable non-transitory tangible storage medium. The storage medium for the computer program may be various, including hard disk drive (HDD), solid state drive (SSD), and flash memory.

What is claimed is:

1. A driving assistance system comprising:
an external sensor that detects an environment around a vehicle;
a motion sensor, including a plurality of sensors, that detects motion of a driver; and
a controller, including a processor and a memory, that executes assistance control for the vehicle to avoid collision with an object,
wherein the controller is configured to:
determine whether or not a current situation is a risk situation where there is a possibility of the collision with the object, based on an output signal of the external sensor;
execute the assistance control based on determining that the current situation is the risk situation;
determine whether or not a preparatory action for avoiding the collision has been performed by the driver, based on an output signal of the motion sensor;
change execution timing of the assistance control depending on whether or not the preparatory action has been performed within a given determination time period; and
change, among the plurality of sensors in the motion sensor, a combination of sensors used to determine whether the preparatory action has been performed, according to traveling scene.

2. The driving assistance system according to claim 1, wherein
the motion sensor is configured to be capable of detecting the preparatory action of a plurality of types, and
a risk perception level is set for each preparatory action, and
the driving assistance system is configured to control the execution timing of the assistance control when the preparatory action has been performed within the determination time period so that the higher the risk perception level set for the preparatory action having been performed is, the later the execution timing of the assistance control is.

3. The driving assistance system according to claim 1, wherein
the motion sensor includes a foot sensor that generates and outputs data on foot motion of the driver, and
the foot sensor includes an acceleration pedal sensor that generates data indicating a depression amount of an accelerator pedal and a brake pedal sensor that generates data indicating a depression amount of a brake pedal and a foot position sensor that detects foot position,
the controller is configured to:
when the depression amounts of the accelerator pedal and the brake pedal are less than or equal to given values, enable the foot position sensor to determine, using a detection result of the foot position sensor, whether or not the preparatory action has been performed, and
when the depression amount of the accelerator pedal or the brake pedal exceeds the given value, determine, without using the detection result of the foot position sensor, whether or not the preparatory action has been performed, based on time-series data of the depression amounts of the accelerator pedal and the brake pedal.

4. The driving assistance system according to claim 1, wherein
the motion sensor includes a foot sensor that generates and outputs data on foot motion of the driver, and
the foot sensor includes a foot camera that images an area including a brake pedal and an accelerator pedal, and
the controller is configured to acquire data indicating the foot motion by analyzing an image of the foot camera and determine whether or not the preparatory action has been performed, based on the data indicating the foot motion.

5. The driving assistance system according to claim 1, wherein
the motion sensor includes a pressure sensor that detects pressure acting on a seat surface of a driver seat, and
the controller is configured to, upon the pressure having changed in a given pattern, determine that the preparatory action has been performed.

6. The driving assistance system according to claim 1, wherein
the motion sensor includes a head sensor that generates and outputs data on motion of the driver's head, and
the controller is configured to:
based on the data on the motion of the head output by the head sensor, determine whether the head has moved in a given pattern within the determination time period; and
upon the head having moved in the given pattern within the determination time period, determine that the preparatory action has been performed.

7. The driving assistance system according to claim 1, wherein
the motion sensor includes a hand sensor that generates and outputs data on motion of the driver's hand, and
the controller is configured to:
based on the data on the motion of the hand output by the hand sensor, determine whether or not the hand has moved in a given pattern within the determination time period; and
upon the hand having moved in the given pattern within the determination time period, determine that the preparatory action has been performed.

8. The driving assistance system according to claim 1 further comprising
a line-of-sight detector that detects a line-of-sight direction of the driver,
wherein the controller is configured so that:
the execution timing of the assistance control is settable to any of standard timing, late timing, and early timing;
the controller sets the execution timing of the assistance control to the late timing when the preparatory action that is of specific has been performed; and
the controller sets the execution timing of the assistance control to the early timing when the object possible to collide with the vehicle is in the line-of-sight direction of the driver and no preparatory action has been detected.

9. A non-transitory storage medium storing a program comprising instructions causing a computer to perform:
determining whether or not a current situation is a risk situation where there is a possibility of collision with an object, based on an input signal from an external sensor detecting an environment around a vehicle;
executing assistance control for the vehicle to avoid the collision with the object, based on determining that the current situation is the risk situation;
determining whether or not a preparatory action for avoiding the collision has been performed by a driver, based on an input signal from a motion sensor, including a plurality of sensors, that detects the driver's motion;
change execution timing of the assistance control depending on whether or not the preparatory action has been performed within a given determination time period; and
change, among the plurality of sensors in the motion sensor, a combination of sensors used to determine whether the preparatory action has been performed, according to traveling scene.

10. A driving assistance device comprising:
a communicator for communicating with another device; and
a controller, including a processor and a memory, that executes assistance control for a vehicle to avoid collision with an object based on data received by the communicator,
wherein the controller is configured to:
acquire, via the communicator, a detection result of an external sensor detecting an environment around the vehicle;
determine whether or not a current situation is a risk situation where there is a possibility of the collision with the object, based on an output signal of the external sensor;
execute the assistance control, based on determining that the current situation is the risk situation;
acquire via the communicator, a detection result of a motion sensor, including a plurality of sensors, detecting motion of a driver;
determine whether or not a preparatory action for avoiding the collision has been performed by the driver, based on the detection result of the motion sensor;
change execution timing of the assistance control depending on whether or not the preparatory action has been performed within a given determination time period; and
change, among the plurality of sensors in the motion sensor, a combination of sensors used to determine whether the preparatory action has been performed, according to traveling scene.

11. A driving assistance device comprising:
a communicator for communicating with another device; and
a controller, including a processor and a memory, that executes behavior control for a vehicle to avoid collision with an object based on data received by the communicator, the behavior control including steering control or braking control,
wherein the controller is configured to:
acquire, via the communicator, a detection result of an external sensor detecting an environment around the vehicle;
determine whether or not a current situation is a risk situation where there is a possibility of the collision with the object, based on an output signal of the external sensor;
start the behavior control based on determining the current situation is the risk situation;
acquire, via the communicator, a detection result of a motion sensor detecting motion of the driver;
determine whether or not a preparatory action for avoiding the collision has been performed by the driver, based on the detection result of the motion sensor; and
change magnitude of the behavior control depending on whether or not the preparatory action has been performed within a given determination time period.

12. A driving assistance system comprising:
an external sensor that detects an environment around a vehicle;
a motion sensor that detects motion of a driver; and
a controller, including a processor and a memory, that executes behavior control for the vehicle to avoid collision with an object, the behavior control including steering control or braking control,
wherein the controller is configured to:
determine whether or not a current situation is a risk situation where there is a possibility of the collision with the object, based on an output signal of the external sensor;
start the behavior control based on determining that the current situation is the risk situation;
determine whether or not a preparatory action for avoiding the collision has been performed by the driver, based on an output signal of the motion sensor; and
change magnitude of the behavior control depending on whether or not the preparatory action has been performed within a given determination time period.

13. A non-transitory storage medium storing a program comprising instructions causing a computer to perform:
determining whether or not a current situation is a risk situation where there is a possibility of collision with an object, based on an input signal from an external sensor detecting an environment around a vehicle;
starting behavior control for the vehicle to avoid the collision with the object, based on determining the current situation is the risk situation, wherein the behavior control includes steering control or braking control;
determining whether or not a preparatory action for avoiding the collision has been performed by the driver, based on an input signal from a motion sensor detecting motion of the driver; and
changing magnitude of the behavior control depending on whether or not the preparatory action has been performed within a given determination time period.
